(19) United States
(12) Patent Application Publication
(10) Pub. No.: US 2012/0083290 A1
(43) Pub. Date: Apr. 5, 2012

(54) SYSTEM AND METHOD FOR MEASURING A SIGNAL OF A COMMUNICATION SYSTEM

(75) Inventors: Jung Soo Jung, Seongnam-si (KR); Kyeong In Jeong, Hwaseong-si (KR)

(73) Assignee: SAMSUNG ELECTRONICS CO., LTD., Suwon-city, Gyeonggi-do (KR)

(21) Appl. No.: 13/377,220

(22) PCT Filed: Jun. 1, 2010
(86) PCT No.: PCT/KR2010/003494

§ 371 Date: Dec. 9, 2011

(30) Foreign Application Priority Data
Jun. 9, 2009 (KR) 10-2009-0051048

(51) Int. Cl. H04W 24/00

(52) U.S. Cl. 455/456.1

(57) ABSTRACT

The present invention relates to a method which involves resetting a signal-measuring cycle for an object system to a specific initial value when a terminal which communicates with one system has changed the location thereof by a value more than a specific reference value, and determines whether or not the intensity of the signal or phase information measured in a source system which is in communication with the terminal has changed by a value higher than a specific value, by means of determining whether or not the terminal has changed the location thereof, under the condition mobile communication system using different wireless connection techniques coexist.

### BACKGROUND OF THE INVENTION

1. Field of the Invention

The present invention relates to a communication apparatus and method of a mobile communication system, and more particularly, to an apparatus for measuring a signal of a system in a mobile communication network operating different mobile communication systems.

2. Description of the Related Art

There is a Code Division Multiple Access (referred to as ‘CDMA’ hereinafter) High Rate Packet Data (HRPD) system as a representative mobile communication system having a channel structure for transmitting high speed data of 3G mobile communication systems. The CDMA HRPD system means an HRPD system using a CDMA scheme.

FIG. 1 is a view illustrating a configuration of an HRPD system.

Referring to FIG. 1, the HRPD system is configured by a Packet Data Service Node (referred to as ‘PDSN’ hereinafter) connecting with an Internet and for transmitting high speed packet data to a base station 103 and a Packet Control Function (referred to as ‘PCF’ hereinafter) for controlling the base station 103. The base station 103 communicates with a plurality of terminals 104 in a wireless scheme, and transmits the high speed packet data to a terminal with the best transmission rate. 4G mobile communication system evolved from the 3G mobile communication system such as HRPD system aims transmission speed higher than 20 Mbps for ultra-high media service, and uses an orthogonal frequency such as Orthogonal Frequency Division Multiplexing (referred to as ‘OFDM’) scheme. There is an LTE or LTE-advanced system advancing standardization in 3GPP as a representative example of 4G mobile communication systems.

FIG. 2 is a view illustrating a configuration of an LTE communication system being a representative example of 4G mobile communication systems.

Referring to FIG. 2, the LTE system includes a base station 202 communicating with a plurality of terminals 201 in a wireless scheme and providing an ultra-high speed multimedia service; a Mobility Management Entity (MME) and Serving gateway (referred to as ‘MME/S-GW’) 203 for managing mobility of the terminals, call processing, and data transmission path; and a Packet data network (PDN) gateway (referred to as ‘P-GW’ hereinafter) 204.

With a continuous development of a current mobile communication technology, there occurs a situation under mobile communication systems using different wireless connection techniques coexit at the same location. FIG. 3 is a view illustrating a case where a dual mode terminal 301 is located at an overlapping zone of coverage of an HRPD base station 302 and coverage of an LTE base station 303. Further, the dual mode terminal 301 may become a terminal that supports both of HRPD and LTN wireless connection techniques. In this situation, the dual mode terminal 301 may give a priority to a more evolved wireless connection system to attempt connection. However, in general, in a wireless connection system of a next generation, a case having coverage narrower than that of a wireless connection system of a previous generation in an initial introduction may occur. Accordingly, as shown in FIG. 3, a dual mode terminal 301 is located within coverage of an HRPD system and may communicate with an HRPD system. However, the dual mode terminal 301 is located outside a coverage boundary region of an LTE system and cannot communicate with the LTE system. In this situation, when the user or an enterprise gives a connection priority in an LTE system, the dual mode terminal 301 attempts continuous signal measurement to check whether there is a connectable LTE base station. There arises a problem in that power consumption is great and an idle time is short.

The power consumption problem occurs where a terminal exists in a region of an LTE system. FIG. 4 is a view illustrating a case where the dual mode terminal 401 cannot receive an LTE signal due to peripheral situations such as interferences in an LTE frequency band although it is located at a coverage zone of HRPD 402 and LTE 403 systems. As shown in FIG. 4, the region partially existing in the system is called an LTE coverage hole 404. The power consumption problem illustrated in FIG. 3 may equally occur when a terminal is located in a coverage hole.

As illustrated above, with development of a mobile communication technology, when wireless connection techniques of different generations are used, power consumption occurs according to attempt of continuous signal measurement of a corresponding mobile communication system where the terminal is located at a region capable of not accessing a mobile communication system of a priority. Further, when the terminal is located at a region that cannot receive a signal due to interference in a mobile communication system region, power consumption is increased.

### SUMMARY OF THE INVENTION

An embodiment of the present invention suggests a method for determining presence of another system in a state that a terminal supporting mobile communication systems using different wireless connection techniques. An embodiment of the present invention suggests a method for efficiently signal strength of a system while a dual mode terminal communicates with one system under the condition mobile communication systems using different wireless connection techniques coexit.

An embodiment of the present invention suggests a method which involves resetting a signal-measuring cycle for an object system to a specific initial value when a terminal which communicates with one system has changed the location thereof by a value more than a specific reference value, under the condition mobile communication system using different wireless connection techniques coexist. Further, the present invention suggests a method for determining whether or not the intensity of the signal or phase information measured in a source system which is in communication with the terminal has changed by a value higher than a specific value, by means of determining whether or not the terminal has changed the location thereof.

An embodiment of the present invention suggests a method which involves resetting a signal-measuring cycle for an object system to a specific initial value when a terminal which communicates with one system has changed the location thereof by a value more than a specific reference value, under the condition mobile communication system using different wireless connection techniques coexist. Further, the present invention suggests a method for determining whether or not the intensity of the signal or phase information measured in a source system which is in communication with the terminal has changed by a value higher than a specific value, by means of determining whether or not the terminal has changed the location thereof.

In accordance with an aspect of the present invention, a method for measuring a signal of a mobile communication system by a terminal connecting with different mobile communication systems, including: performing an inter-RAT measuring procedure for measuring a signal of a target system in a signal measuring period, and analyzing a strength of the measured signal to determine whether a target system is detected; increasing a signal measuring period for the target system when the target system is not detected, and storing a location of a terminal; and setting the signal measuring period of the target system to a default value when the target system is detected, and initializing location information of the terminal.

In accordance with another aspect of the present invention, a method for measuring a signal of a mobile communication system by a terminal connecting with different mobile communication systems, including: performing an inter-RAT measuring procedure for measuring a signal of a target system in a signal measuring period, and analyzing a strength of the measured signal to determine whether a target system is detected; increasing a signal measuring period for the target system when the target system is not detected, and storing received strength of a currently connected serving system; and setting the signal measuring period of the target system to a default value when the target system is detected, and initializing the received strength of the serving system.

In accordance with another aspect of the present invention, a mobile communication system including: at least two mobile communication systems using different wireless connection techniques, and including a serving system connecting with a terminal and a target system not connecting with the terminal; a terminal for testing a measured signal strength of a target system in a measuring period to perform an inter-RAP procedure for determining whether a target system is detected, increasing a signal measuring period for the target system when the target system is not detected to store location information of the terminal, and initializing the measuring period as a default value when the target system is detected and measuring a signal of the mobile communication system initializing location information of the terminal.

### BRIEF DESCRIPTION OF THE DRAWINGS

The objects, features and advantages of the present invention will be more apparent from the following detailed description in conjunction with the accompanying drawings, in which:

FIG. 1 is a view illustrating a configuration of a High Rate Packet Data (HRPD) system;

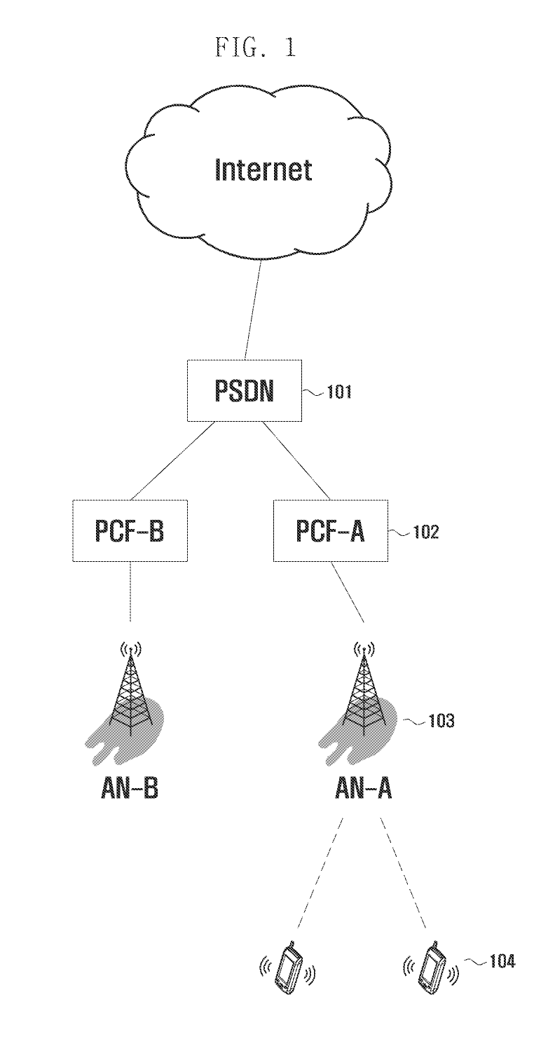

FIG. 2 is a view illustrating a configuration of an LTE communication system being a representative example of 4G mobile communication systems;

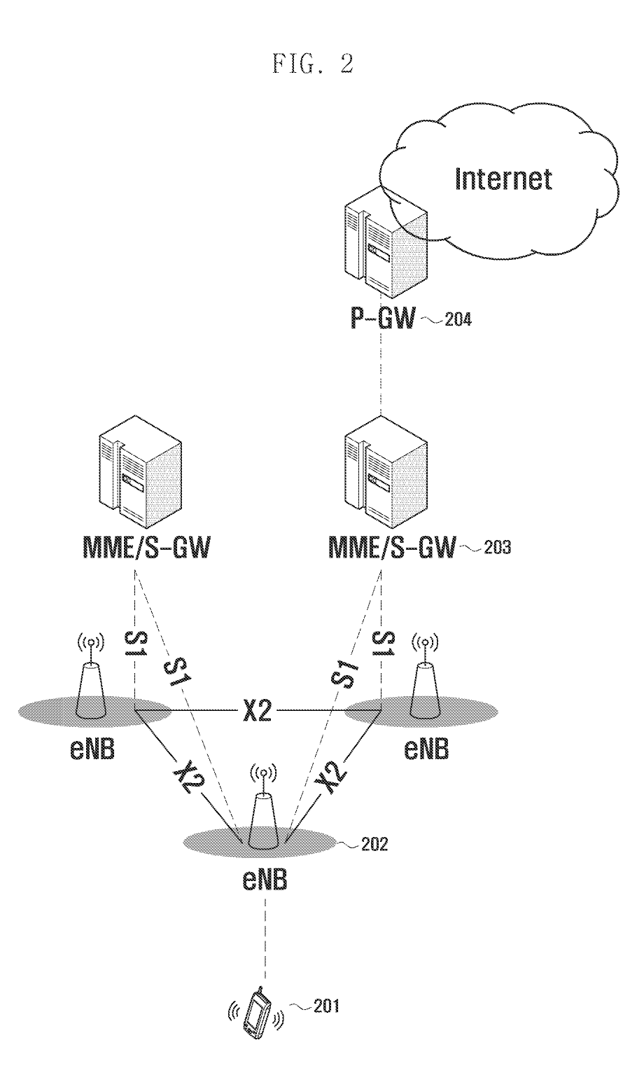

FIG. 3 is a view illustrating a case where a dual mode terminal supporting HRPR and LTE wireless connection techniques is located at an overlapping zone of coverage of an HRPD base station and coverage of an LTE base station;

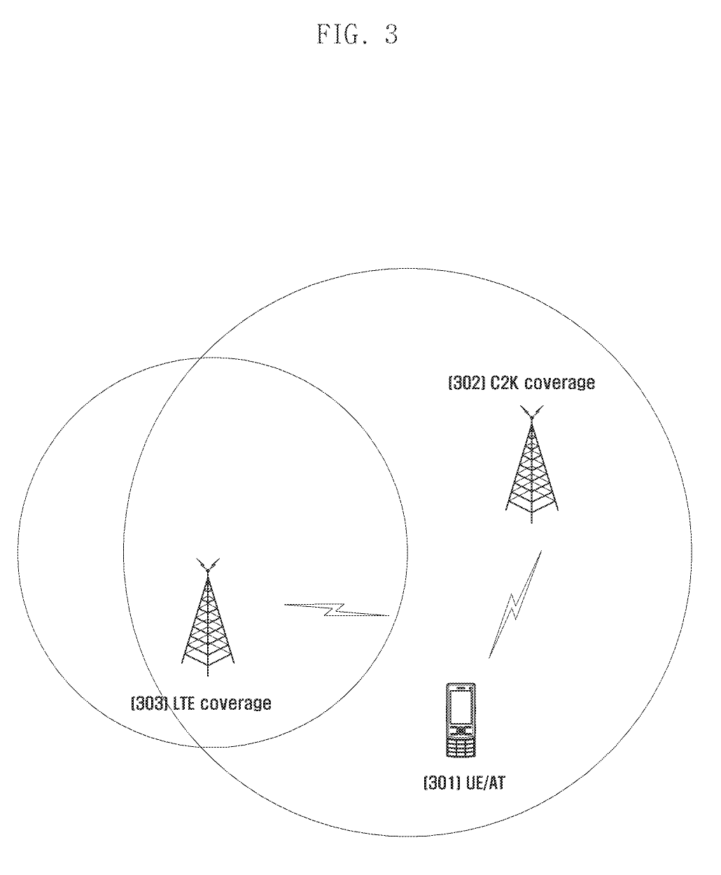

FIG. 4 is a view illustrating a case where the dual mode terminal 401 cannot receive an LTE signal due to peripheral situations such as interferences in an LTE frequency band although it is located at a coverage zone of HRPD 402 and LTE 403 systems;

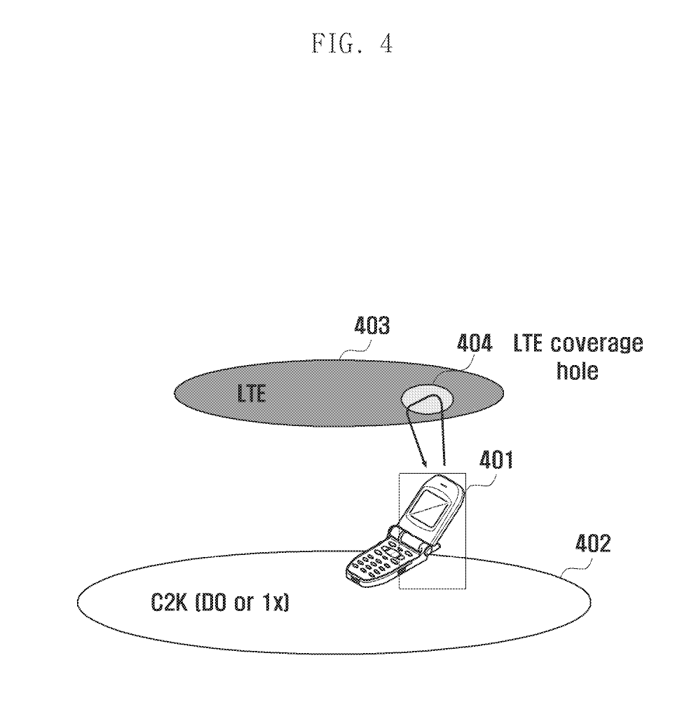

FIG. 5 is a view illustrating a service method of an LTE coverage hole according to an embodiment of the present invention;

FIG. 6 is a view illustrating an example of a flowchart illustrating a signal measuring operation for a target system according to an embodiment of the present invention;

FIG. 7 is a view illustrating an example of a flowchart illustrating an operation for resetting a signal measuring period for a target system according to an embodiment of the present invention;

FIG. 8 is a flowchart illustrating another example for determining location variation based on a received signal of a current serving base station in communication with and performing signal measuring operation for a target system according thereto;

FIG. 9 is a flowchart illustrating another example for determining location variation based on a received signal of a current serving base station in communication with and resetting signal measuring operation for a target system according thereto; and

FIG. 10 is a block diagram of a terminal and a base station for measuring a signal for a target under the condition mobile communication systems using different wireless connection techniques coexit operating according to the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

There are a 4G mobile communication system for providing ultra-high speed multimedia service 0| [symbol] 1G of an analog scheme, 2G of digital scheme, and 3G for providing high speed multimedia service of IMT-2000 as mobile communication systems being a target of an embodiment of the present invention.

Hereinafter, a terminal means a terminal capable of communicating with at least two mobile communication systems using different wireless connection techniques. In this case, the mobile communication system may be divided into a serving system communicating with the terminal and systems not communicating with the terminal. In this case, the non-communication system may be used as a term of another system or a target system.

Under the condition mobile communication systems using different wireless connection techniques coexist, a terminal supporting a wireless connection technique of the mobile communication systems continuously measures signal strength of another system during communication with one system to cause power consumption of the terminal and reduce an idle time.

An embodiment of the present invention suggests a method for determining presence of another system while communicating with one system in a state that a terminal supporting mobile communication systems using different wireless connection techniques, and which compares signal strength of another system with a certain reference value and determines that a target system exist when the signal strength of another system with a certain reference value. The reference value is transferred upon call setting or termination of the terminal, or set when the terminal and a base station negotiate setting values associated with wireless connection, or transmitted to all terminals in the base station in a broadcasting form.

Further, the present invention suggests a method for measuring a signal of another system every set period by a terminal communicating with one system under the condition mobile communication systems using different wireless connection techniques. The present invention further suggests a method for increasing or reducing a signal measuring period of a target system according to presence of a target system. In the present invention, as illustrated above, it is assumed that the present invention compares signal strength of a target system with a certain reference value as illustrated previously to determine presence of the target system. Information containing an initial value, an increased value, a reduced value, a maximum value of a measuring period for a target system suggested from the present invention is transferred upon call setting or termination of the terminal, or set when the terminal and a base station negotiate setting values associated with wireless connection, or transmitted to all terminal in the base station in a broadcasting form.

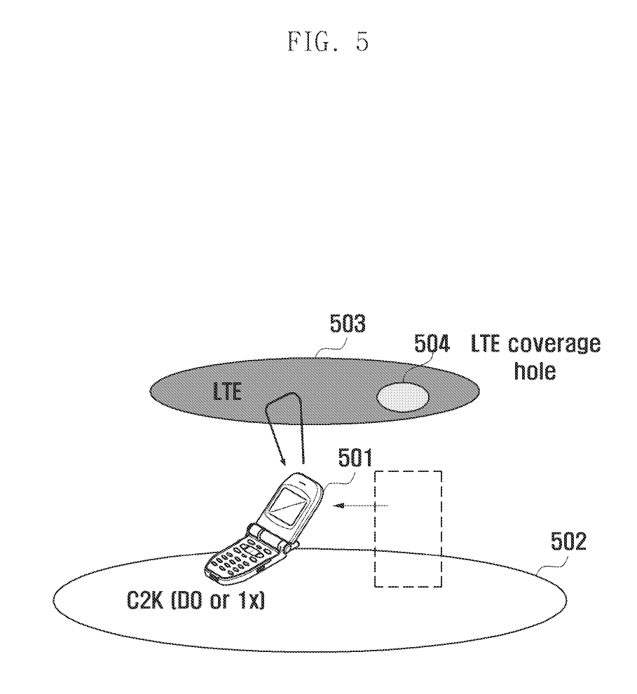

In this case, the terminal sets a measuring period with respect to a target system located at a region in which the target system is absent, a boundary region of the target system, or a coverage hole of the target system great to prevent unnecessary power consumption. FIG. 5 is a view illustrating a service method of an LTE coverage hole according to an embodiment of the present invention. It is assumed in FIG. 5 that a communication serving system is an HRPD system and another system is an LTE system.

Referring to FIG. 5, a terminal changing a signal measuring period with respect to the target system moves to a coverage 503 zone of the target system after it located at a coverage hole 504 of the target system, the terminal should restores a measuring period with respect to the target system to an initial value to perform an idle handoff to the target system at a suitable time point. However, the terminal needs signal measurement with respect to the target system to know whether the terminal is separated from the coverage hole 504. However, it may take a long time to determine a terminal using a longer measuring period for power efficiency to determine a fact that it is separated from the coverage hole.

An embodiment of the present invention suggests a method which involves resetting a signal-measuring cycle for an object system to a specific initial value when a terminal which communicates with one system has changed the location thereof by a value more than a specific reference value, under the condition mobile communication system using different wireless connection techniques coexist. Further, the present invention suggests a method for determining whether or not the intensity of the signal or phase information measured in a source system which is in communication with the terminal has changed by a value higher than a specific value, by means of determining whether or not the terminal has changed the location thereof. The present invention suggests that a terminal measures a plurality of base station signals in a system in communication with the terminal to determine whether location information determined through a trigonometric measurement between the signals is changed by greater than a certain reference value. The present invention suggests a method for determining a location of a terminal has changed by a value higher than a specific value using a third location measurement system such as GPS, by means of determining whether or not the terminal has changed the location thereof.

When the terminal according to a method of the present moves from a zone except for coverage of a target system, a boundary zone of the target system or a coverage hole of the target system to a coverage region of the target system, the terminal initially sets a measuring period with respect to the target system to an initial value to efficiently perform an operation of idle handoff.

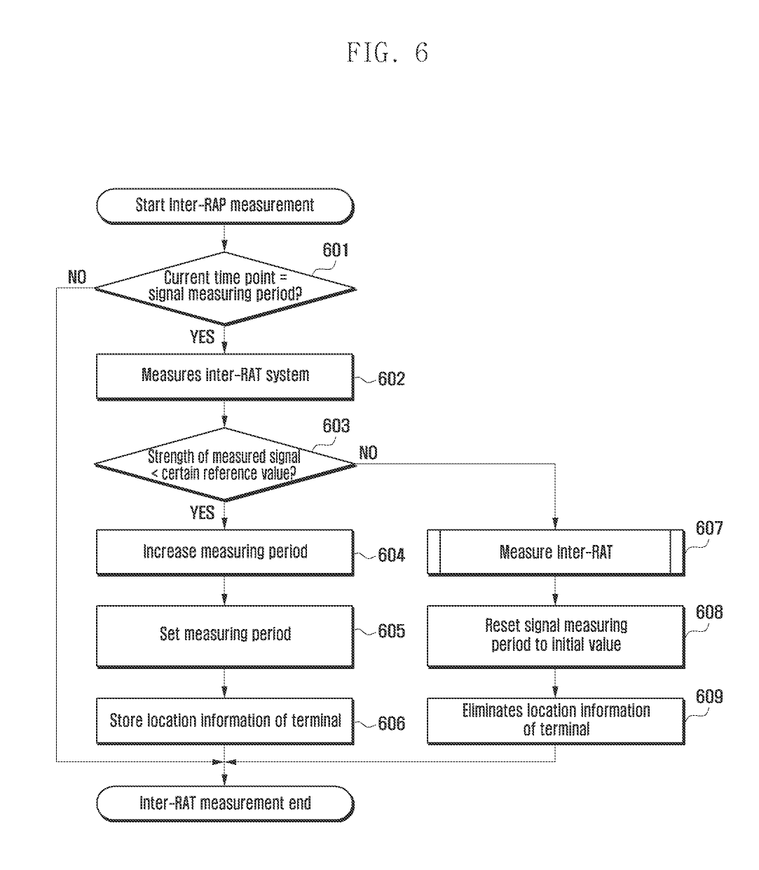

FIG. 6 is a view illustrating an example of a flowchart illustrating a signal measuring operation for a target system according to an embodiment of the present invention.

Referring to FIG. 6, a terminal performing a signal measuring operation with respect to the target system determines whether a current time point is a signal measuring period MeasurementPeriod with respect to the target system (601). If the current time is not a signal measuring period with respect to the target system, the terminal senses it to terminate a signal measuring operation (inter-RAT Measurement). However, if the current time point is a signal measuring period with respect to the target system, the terminal senses it (601), and measures an inter-RAT system (602). Next, the terminal compares whether a strength of a measured signal is less than a certain reference value such that it determines whether the target system is detected (603). If the target system is not detected, the terminal increases a signal measurement period with respect to the target system by a certain increased value (MeasurementPeriod_backoff) (MeasurementPeriod+=MeasurementPeriod_backoff) (604), and sets a measuring period (605). The measurement period is set to a small value of the increased measurement period or a set maximum value. That is, when the increased signal measurement period with respect to the target system exceeds a preset maximum value at step 604, it is set to a maximum value (MeasurementPeriod=Min(MeasurePeriod, MeasurementPeriod_Max). When the increased signal measurement period with respect to the target system is less than the preset maximum value, it is set to the increase signal measurement period (605). The terminal stores information on a location in which the target system is not detected to terminate a signal measuring operation (Measurement inter-RAT system) (606).

When the target system is detected because the signal strength of the target system measured in step 603 is greater than a certain reference value, the terminal performs an operation associated with signal measurement of the target system (607). Then, the terminal resets a signal measuring period with respect to the target system to an initial value (MeasurementPeriod=MeasurementPeriod_default) (608), eliminates information stored in a location in which the target system is not detected (609), and terminates a signal measuring operation (Measurement inter-RAT system).

Referring to FIG. 6, the terminal compares a signal strength of another system while communicating with one system with a certain reference value. When the signal strength is greater than the reference value, the terminal determines that there is a target system. In this case, when there is the target system (that is, the target system is not detected), the terminal sets a measuring period great and stores a location of the current terminal. If there is the target system (that is, the target system is detected), the terminal performs an inter-RAT measuring operation, and resets the measuring period as a default value, and eliminates location information of the terminal. In this case, a measuring period set to the default has a time period short than that set when the target system is not detected. Accordingly, if the target system is not detected, the terminal sets the measuring period long. If the target system is detected, the terminal performs an Inter-RAT measuring operation while setting a measuring period.

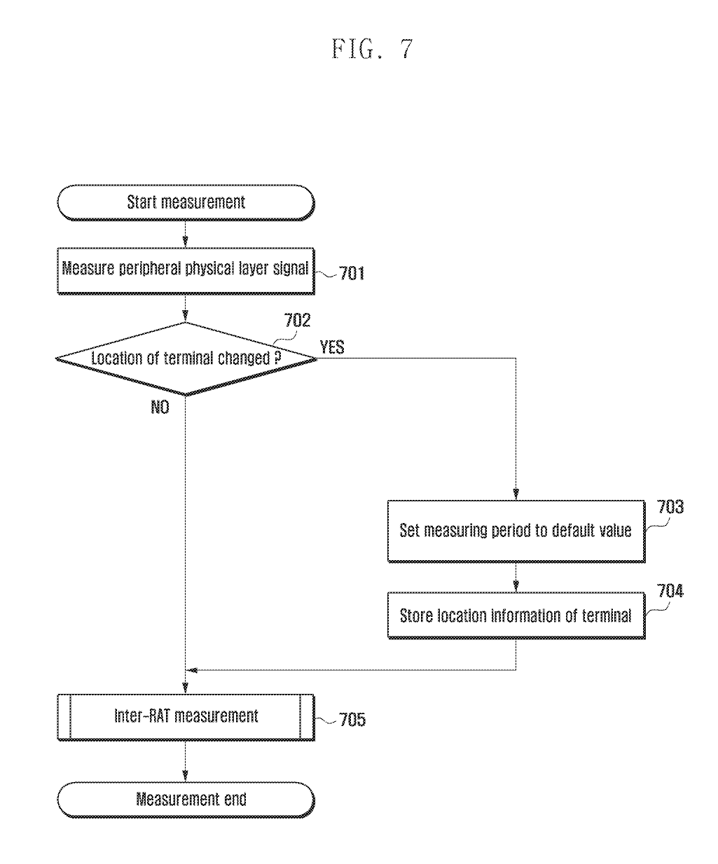

FIG. 7 is a view illustrating an example of a flowchart illustrating an operation for resetting a signal measuring period for a target system according to an embodiment of the present invention.

A terminal measures peripheral information including location information of the terminal for each physical layer signal measuring opportunity (701). Next, the terminal determines whether a location of a terminal is changed (702). In a method for determining location change by the terminal, the terminal tests whether a current location of the terminal is separated from a location in which a target system is not detected and stored in step 606 of FIG. 6 by a certain value to determine presence of location change. If the current location of the terminal is moved by greater than a certain value, the terminal determines that the location of the terminal is changed. Accordingly, if the location is changed by greater than a sufficient degree, the terminal senses it (702), resets a signal measuring period with respect to the target system to an initial value (MeasurementPeriode=MeasurementPeriod_default) (703), eliminates information storing a location in which the target system is not detected (704), and proceeds to step 705.

Step 705 is a step of performing a signal measuring operation, and is performed when a location of the terminal is not changed or after performing step 704. That is, the terminal attempts signal measurement for the target system (705) and terminates a physical layer signal measuring operation. The signal measuring procedure for the target system of step 705 may become an operation illustrated in FIG. 6.

As illustrated previously, in a state where a terminal capable of communicating with mobile communication systems using different wireless connection techniques communicates with one system, when the location is changed by greater than a certain reference value, the terminal resets a signal measuring period for the target system, and performs an Inter-RAT measuring operation.

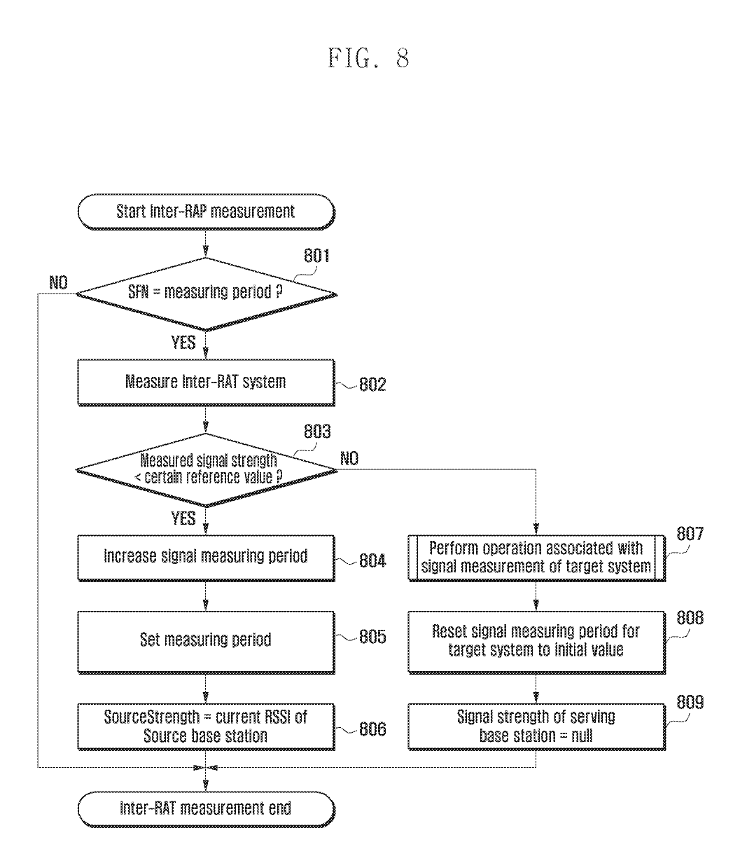

FIG. 8 is a flowchart illustrating another example for determining location variation based on a received signal of a serving base station of a serving system and performing signal measuring operation for a target system according thereto.

Referring to FIG. 8, a terminal performing a signal measuring operation for the target system determines whether a current system time SFN is a signal measuring period (MeasurementPeriod). If the current time point is not the signal measuring period, the terminal senses it (801), and terminates a signal measuring operation (inter-RAT Measurement). However, if the current time point is the signal measuring period, the terminal senses it (801), and measures a signal for a system (802). Then, the terminal compares whether the measured signal strength is less than a certain reference value to determine whether the target system is detected (803). If the target system is not detected, the terminal increases the signal measuring period for the target system by a certain value (MeasurementPeriod_backoff) (MeasurementPeriod+=MeasurementPeriod_backoff) (804), and sets a measuring period for the target system (805). The measuring period is set to a smaller one of the increased measuring period or a set maximum value. If a signal measuring period for the target system increased in step 604 exceeds a preset maximum value, it is set as a maximum value (MeasurementPeriod=Min(MeasurePeriod, MeasurementPeriod_Max). If the signal measuring period for the target system increased in step 604 is less than the preset maximum value, it is determined as a signal measuring period increased in step 605. Next, the terminal sets an intensity of a serving base station as a current intensity of a serving based station (SourceStrength=current RSSI of Source base station), and terminates a signal measuring operation (806).

However, when the target system is detected because the measured signal strength of the target system in step 803 is greater than the certain reference value, the terminal performs an operation associated with signal measurement of the target system (807). Next, the terminal resets a signal measuring period for the target system to an initial value (MeasurementPeriod=MeasurementPeriod_default) (808), sets a signal strength of a serving base station to null (SourceStrength=NULL) (809), and then terminates a signal measurement operation (Measurement inter-RAT system)

An entire procedure of FIG. 8 is identical with that of FIG. 6. However, unlike an operation of step 606, the terminal stores RSSI in a currently communication with serving base station in step 806 of FIG. 8 when the target system is not detected. Unlike step 609 of FIG. 6, the terminal initializes a stored RSSI of the serving base station in step 809 of FIG. 8.

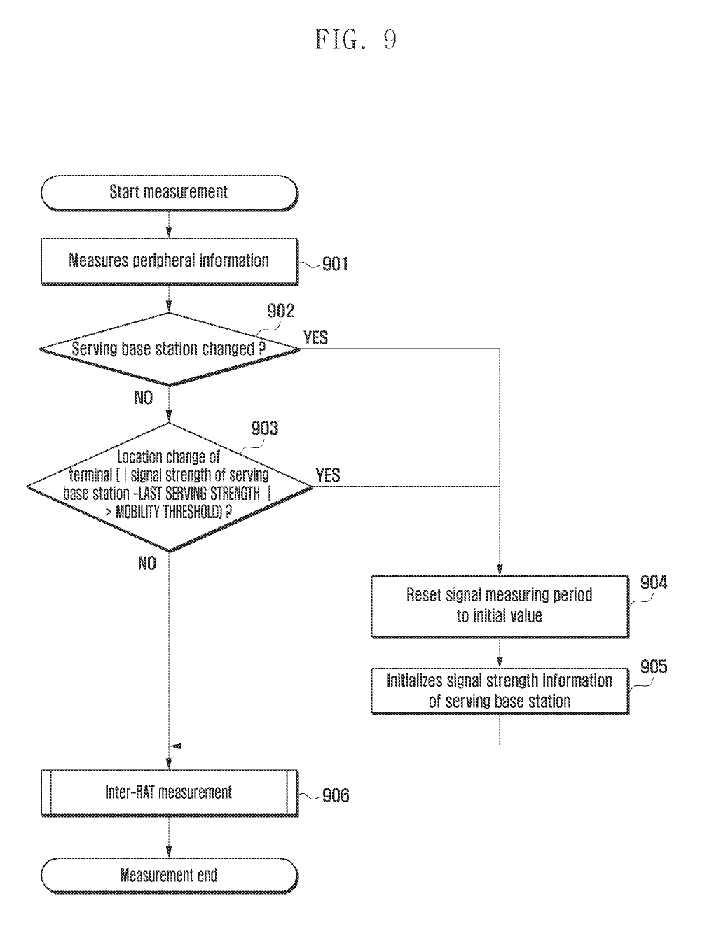

FIG. 9 is a flowchart illustrating another example for determining location variation based on a received signal of a serving base station and resetting signal measuring operation for a target system according thereto.

Referring to FIG. 9, a terminal measures peripheral information containing location information of the terminal for each physical layer signal measuring opportunity (901). Next, the terminal determines whether a serving base station is changed (902). That is, the terminal determines whether a currently communicating serving base station is changed based on information measured in step 901. If the serving base station is not changed, the terminal tests signal strength of the serving base station (903). A method for testing a signal strength of the serving base station determines whether a current signal strength of the serving base station is changed by greater than a certain reference value in comparison with a signal strength of a serving base station when the target system stored in step 806 of FIG. 8 is not detected (|Signal strength of serving base station−LastServingStrength|>MobilityThershold). In this case, the reference value (MoblilityThreshold) may be transferred upon call setting or termination of the terminal, may be set when the terminal and the base station negotiate setting values associated with wireless connection, or may be transmitted to all terminals in a base station in a broadcasting form. When it is sensed at step 903 that the signal strength of the serving base station is changed by greater than a certain reference value, or it is sensed at step 902 that the serving base station is changed, the terminal determines that the location is changed by greater than a sufficient degree. The terminal resets a signal measuring period for the target to an initial value (904), initializes signal strength information of a serving base station corresponding to a location in which the target system is not detected (905), and then performs a signal measuring procedure for the target system.

The terminal determines that signal strength of the serving base station is changed by greater than a certain reference value (903) or after performing step 905, the process proceeds to step 906 and a signal measuring procedure of the target system is performed. That is, the terminal attempts signal measurement for a target system for each physical layer signal measurement opportunity (906), and terminates a physical layer signal measuring operation. The signal measuring procedure for a target system at step 906 may become an operation illustrated in FIG. 8.

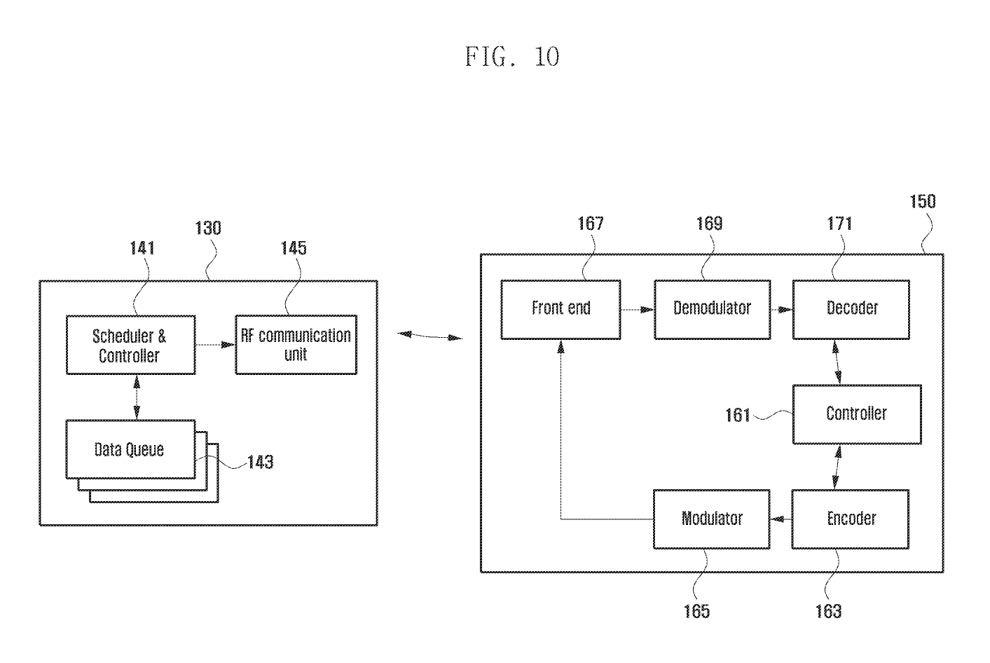

FIG. 10 is a block diagram of a terminal and a base station for measuring a signal for a target under the condition mobile communication systems using different wireless connection techniques coexit operating according to the present invention.

A base station device 130 controlling a signal measuring period for a target system according to a method of the present invention includes a Scheduler & Controller 141, an RF communication unit 145, and a Data Queue 143. A terminal device 150 performing signal measurement for a target system according to the method of the present invention includes a Front end 167, a demodulator 169, a decoder 171, a controller 161, an encoder 163, and a modulator 165.

A controller (not shown) of the base station may set various parameters controlling a signal measuring period for the target system upon call setting or termination, when the terminal and the base station negotiate setting values associated with wireless connection, or transmit various parameters to all terminals in the base station in a broadcasting form according to the method of the present invention. The data queue 143 of the base station device stores data received from an upper network node in the queue for each terminal or service. The scheduler & controller 141 classifies data stored for each queue into specific user data or certain queue data in consideration of forward channel situation information, service characteristics, and fairness, and control the data. The RF communication unit transmits the classified and controlled data signal or control signal to the terminal device.

The controller 161 of the terminal device performs for increasing or reducing a signal measurement period of the target system. When the location is changed by greater than a certain reference value, the controller 161 resets the signal measuring period for the target system to a certain initial value. The terminal detects a signal of the target system received by the front end 167 for each determined measuring period of the target system. The terminal demodulates a detected in the demodulator 169.

A terminal supporting wireless connection techniques of mobile communication systems may efficiently signal strength of another system while communicating with one system under the condition mobile communication system using different wireless connection techniques coexist.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for measuring a signal of a mobile communication system by a terminal connecting with different mobile communication systems, the method comprising:
performing an inter-RAT measuring procedure for measuring a signal of a target system in a signal measuring period, and analyzing a strength of the measured signal to determine whether a target system is detected;
increasing a signal measuring period for the target system when the target system is not detected, and storing a location of a terminal; and
setting the signal measuring period of the target system to a default value when the target system is detected, and initializing location information of the terminal.

2. The method of claim 1, further comprising:
measuring a signal of a serving base station;
setting the signal measuring period of the target system to a default value when a location is changed during the signal measuring procedure to initialize the location information of the terminal; and
performing the inter-RAT measuring procedure.

3. The method of claim 2, wherein determining whether a target system is detected comprises:
comparing the measuring signal of the target system with a set strength of a reference signal; and
determining that the target system is detected when the measuring signal of the target system is less than the strength of the reference signal,
the strength of the reference signal is transmitted to all terminals in the base station in a broadcasting form upon call setting termination of the terminal, when the terminal and a base station negotiate setting values associated with wireless connection.

4. The method of claim 3, wherein a method for determining location change of the terminal comprises determining whether the intensity or phase information measured in a source system which is in communication with the terminal has changed by a value higher than a specific value.

5. The method of claim 3, wherein the method for determining location change of the terminal measures a plurality of base station signals in a system in communication with the terminal to determine whether location information determined through a trigonometric measurement between the signals is changed by greater than a certain reference value.

6. The method of claim 3, wherein the method for determining location change of the terminal determines a location of a terminal has changed by a value higher than a specific value using a third location measurement system such as GPS.

7. The method of claim 4, wherein the signal measuring period of the target system has a measuring period of a default signal with the fastest period.

8. A method for measuring a signal of a mobile communication system by a terminal connecting with different mobile communication systems, the method comprising:
performing an inter-RAT measuring procedure for measuring a signal of a target system in a signal measuring period, and analyzing a strength of the measured signal to determine whether a target system is detected;
increasing a signal measuring period for the target system when the target system is not detected, and storing received strength of a currently connected serving system; and
setting the signal measuring period of the target system to a default value when the target system is detected, and initializing the received strength of the serving system.

9. The method of claim 8, further comprising:
testing whether a received signal strength indicator of a serving base station is changed;
setting the signal measuring period of the target system to a default value when the received signal strength indicator of a serving base station is changed to initialize the location information of the terminal; and
performing the inter-RAT measuring procedure.

10. The method of claim 9, wherein testing whether a received signal strength indicator of a serving base station is changed comprises determining whether a current signal strength of the serving base station is changed by greater than a certain reference value in comparison with a signal strength of a serving base station when the target system stored is not detected (|Signal strength of serving base station−LastServingStrength|>MobilityThershold).

11. The method of claim 10, wherein the reference signal is transmitted to all terminals in the base station in a broadcasting form upon call setting termination of the terminal, when the terminal and a base station negotiate setting values associated with wireless connection.

12. A mobile communication system comprising:
at least two mobile communication systems using different wireless connection techniques, and including a serving system connecting with a terminal and a target system not connecting with the terminal; and
a terminal for testing a measured signal strength of a target system in a measuring period to perform an inter-RAP procedure for determining whether a target system is detected, increasing a signal measuring period for the target system when the target system is not detected to store location information of the terminal, and initializing the measuring period as a default value when the target system is detected and measuring a signal of the mobile communication system initializing location information of the terminal.

13. The mobile communication system of claim 12, wherein the terminal measures a signal of a serving base station, sets a signal measuring period of the target system to a default value when a location is changed during the signal measuring procedure to initialize the location information of the terminal, and performs the inter-RAT measuring procedure.

14. The mobile communication system of claim 13, wherein the terminal compares a measuring signal of a target system with a preset strength of a reference signal, determines that the target system is detected when the preset strength of a reference signal is greater than the measuring signal of a target system, the strength of the reference signal is transmitted to all terminals in the base station in a broadcasting form upon call setting termination of the terminal, when the terminal and a base station negotiate setting values associated with wireless connection.
